(19) United States
(12) Patent Application Publication
(10) Pub. No.: US 2003/0214755 A1
(43) Pub. Date: Nov. 20, 2003

(54) Magnetic disk cartridge

(75) Inventor: Harumi Aoishi, Kanagawa-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/440,190

(22) Filed: May 19, 2003

(30) Foreign Application Priority Data
May 20, 2002 (JP) 143946/2002

(51) Int. Cl. G11B 23/03

(52) U.S. Cl. 360/133

(57) ABSTRACT

A magnetic disk cartridge comprising a magnetic disk medium, a casing for rotatably housing the magnetic disk medium, and dust-removing liners fixed to inner surfaces of the casing that face both sides of the magnetic disk medium. The dust-removing liners are formed from a porous material that has a great number of pores whose size is in a range of 60 to 100 μm.

### BACKGROUND OF THE INVENTION

1. Field of the Invention

The present invention relates to a magnetic disk cartridge in which a magnetic disk medium is rotated within a casing to perform magnetic recording and reproduction, and more particularly to a magnetic disk cartridge in which the inner surface of a casing is provided with dust-removing liners.

2. Description of the Related Art

In conventional magnetic disk cartridges, a magnetic recording medium is constructed of a supporting disk, which is formed from a flexible polyester sheet, etc., and both sides of the supporting disk have magnetic layers, respectively. The magnetic recording medium is rotatably housed in a casing. The casing consists of an upper shell with an upper head slot, and a lower shell with a lower head slot. This kind of magnetic disk cartridge is used primarily as a recording medium for computers, because it is easy to handle and low-cost.

In the above-described magnetic disk cartridge, if there is a speck of dust adhering to the magnetic disk medium, it will cause dropout. The problem of this dropout will arise more easily if the recording density of the magnetic disk medium becomes higher. Hence, for example, most magnetic disk cartridges for 3½-in floppy disks adopt a dust-removing structure, in which the inner surfaces of the upper and lower shells that face both sides of the magnetic disk are provided with upper and lower liners that remove dust, etc. adhering to both sides of the magnetic disk medium.

In conventional magnetic disk cartridges, the above-described dust-removing liners are typically formed from a material that has a napped surface that is brought into contact with the magnetic disk medium. Such a surface makes contact with the magnetic disk being rotated, and flicks off and captures dust, etc. adhering to the magnetic disk. However, in such a conventional magnetic disk cartridge with dust-removing liners, when it is repeatedly used, or if a strong shock is applied when the magnetic disk cartridge is dropped, inserted to a disk drive unit, etc., there is a problem that tiny particles (dust, etc.) captured on the liner surface will scatter and again adhere to the disk surface.

### SUMMARY OF THE INVENTION

The present invention has been made in view of the circumstances described above. Accordingly, it is the object of the present invention to provide a magnetic disk cartridge that is capable of preventing tiny particles (dust, etc.) captured by dust-removing liners from scattering and again adhering to a magnetic disk medium when the cartridge undergoes continuous use or shock.

To achieve this and in accordance with the present invention, there is provided a magnetic disk cartridge comprising a magnetic disk medium, a casing, and dust-removing liners. The casing has head slots through which read/write heads are positioned over both sides of the magnetic disk medium, and rotatably houses the magnetic disk medium. The dust-removing liners are fixed to the inner surfaces of the casing that face both sides of the magnetic disk medium. These liners are formed from a porous material that has a great number of pores whose size is in a range of 60 to 100 μm.

Preferably, the aforementioned porous material is ultra-high molecular-weight-polyethylene (UHMWPE) that has a molecular weight of 4,000,000 to 5,000,000. The porous material preferably has a pore density of 0.45 to 0.85. It is desirable that the porous material contain an antistatic agent.

In the magnetic disk cartridge of the present invention, the dust-removing liners are formed from a porous material that has a great number of pores whose size is in a range of 60 to 100 μm. Because of this, tiny particles (dust, etc.) captured by the dust-removing liner are confined within the pores of the porous material. Hence, even if the magnetic disk cartridge undergoes a shock due to being dropped, etc., or continuous use, tiny particles (dust, etc.) are less liable to scatter from the dust-removing liners. Therefore, the magnetic disk cartridge of the present invention is capable of preventing scattered tiny particles from adhering to the magnetic disk medium again, and obtaining stable disk characteristics.

In conventional magnetic disk cartridges, a dust-removing liner is formed from nonwoven fabric, and this nonwoven fabric also has many small pores in its surface. However, this nonwoven fabric has a pore size that is larger than that of the porous material used in the present invention by 10 times or more. Such a nonwoven fabric hardly has the effect of firmly capturing dust, etc. within its pores. Therefore, even if dust-removing liners are formed from nonwoven fabric, it is impossible to possess the advantages that are obtained by the present invention.

In conventional dust-removing liners formed from nonwoven fabric, the napped surfaces are also arranged to constantly contact with dust-removing liners. In contrast, the porous liners employed in the present invention can be held without contacting the magnetic disk medium during rotation by adjusting the height that the magnetic disk medium is chucked by the spindle of a disk drive unit. This can prevent the magnetic disk medium from being damaged by the dust-removing liners, and can also prevent the torque required to rotate the magnetic disk medium from being increased.

In the case where the porous material of the dust-removing liners contains an antistatic agent, the present invention is also capable of solving the problem of the adhesion of dust, etc. to the magnetic disk medium due to static electricity generated as the magnetic disk medium rotates.

### BRIEF DESCRIPTION OF THE DRAWING

The present invention will be described in further detail with reference to the accompanying drawing wherein:

FIG. 1 is an exploded perspective view showing a magnetic disk cartridge constructed in accordance with a preferred embodiment of the present invention.

### DESCRIPTION OF THE PREFERRED EMBODIMENT

A preferred embodiment of the present invention will hereinafter be described in detail with reference to the drawing.

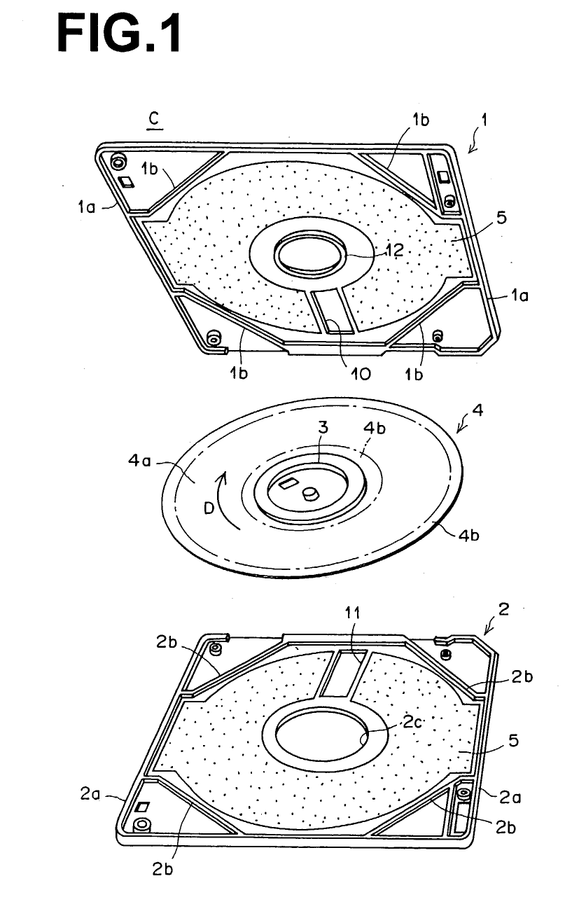

FIG. 1 illustrates a magnetic disk cartridge constructed in accordance with a preferred embodiment of the present invention. A typical example of this magnetic disk cartridge is a cartridge for 3½-in floppy disks.

As illustrated in FIG. 1, the magnetic disk cartridge is equipped with a casing C, a magnetic disk medium 4 rotatably housed in the casing C, and a pair of upper and lower liners 5 disposed to face both sides of the magnetic disk medium 4. The casing C consists of an upper shell 1 and a lower shell 2, which are formed from synthetic resin such as an acrylonitrile-butadiene-styrene copolymer.

The magnetic disk medium 4 is constructed of a supporting disk, which is formed from a flexible polyester sheet, etc., and both sides of the supporting disk have magnetic layers, respectively. The disk medium 4 has a recording area 4a between the inner and outer circumferences 4b, and the central portion of the disk medium 4 is fixedly held on a center core 3.

When the magnetic disk cartridge is inserted in a disk drive unit (not shown), a spindle engages the center core 3 and spins the magnetic disk medium 4 at a predetermined speed in the direction of arrow D.

The upper shell 1 and the lower shell 2 are flat and substantially rectangular in shape. The perimeters of the upper and lower shells 1, 2 are provided with ribs 1a, 2a constituting side walls, and the corners are provided with oblique reinforcement ribs 1b, 2b. The upper and lower shells 1, 2 further have upper and lower head slots 10, 11 through which read/write heads (not shown) are positioned over the recording areas 4a of both sides of the magnetic disk medium 4.

The central portion of the lower shell 2 has a drive spindle hole 2c through which the spindle of the disk drive unit engages the center core 3. On the otherhand, the central portion of the inner surface of the upper shell 1 is provided with an annular protrusion 12, which is positioned inside the annular portion of the outer circumference of the center core 3. This annular protrusion 12 is fitted in the annular portion of the center core 3 and regulates the radial movement of the magnetic disk medium 4. Although not shown, a slidable shutter is provided so it is automatically closed or opened in the upper and lower head slots 10, 11.

The upper and lower liners 5 are fixedly attached to the inner surfaces of the upper and lower shells 1, 2 by supersonic welding, adhesion, etc., and have surfaces that contact approximately the whole surfaces of the recording areas 4a of both sides of the magnetic disk medium 4. These liners 5 are approximately the same in shape (symmetrical in shape). The upper liner 5 has a cutout larger than the upper head slot 10 at a position corresponding thereto, and a center hole larger than the annular protrusion 12. Likewise, the lower liner 5 has a cutout larger than the lower head slot 11 at a position corresponding thereto, and a center hole larger than the drive spindle hole 2c.

The upper and lower liners 5 are formed from a porous material whose pore size is in a range of 60 to 100 μm. An example is ultra-high molecular-weight-polyethylene (UHMWPE) whose molecular weight is in a range of 4,000,000 to 5,000,000. Note that the pore density of this UHMWPE is 0.45 to 0.85. The preferred embodiment employs UHMWPE that contains an antistatic agent such as a quaternary ammonium salt.

If the above-described magnetic disk cartridge is inserted in the disk drive unit (not shown) and rotated, the surfaces of the upper and lower liners 5 lightly contact both sides of the magnetic disk medium 4, respectively. Dust, etc. on both sides of the magnetic disk medium 4 have light adhesion, but if the surfaces of the upper and lower liners 5 make contact with both sides of the magnetic disk medium 4 and a force greater than the static adhesion is exerted on dust, etc., they begin to move. That is, the high rotational speed of the magnetic disk medium 4 not only makes dust, etc. move toward the outer circumference of the disk medium 4, it creates a radially outward flow of air that causes dust, etc. to move toward the outer circumference. Because of this, dust, etc. on both sides of the magnetic disk medium 4 are captured by the upper and lower liners 5 or moved outside the recording area 4a. In this way, dust, etc., are prevented from entering a contact portion between the magnetic disk medium 4 and a read/write head, and dropout is minimized.

In the magnetic disk cartridge of the preferred embodiment, the upper and lower liners 5 are formed from a porous material, so tiny particles (dust, etc.) captured by the liners 5 are confined within the pores of this porous material. Hence, even if the magnetic disk cartridge undergoes a shock due to being dropped, etc., or continuous use, tiny particles (dust, etc.) are less likely to scatter from the dust-removing liners. Therefore, the magnetic disk cartridge of the preferred embodiment is capable of preventing scattered tiny particles from adhering to the magnetic disk medium 4 again, and obtaining stable disk characteristics. In addition, the above-described porous material of the dust-removing liners 5 contains an antistatic agent. Therefore, the preferred embodiment is also capable of solving the problem of the adhesion of dust, etc. to the magnetic disk medium 4 due to static electricity generated as the magnetic disk medium 4 rotates.

While the present invention has been described with reference to the preferred embodiment thereof (cartridge for 3½-in floppy disks), the invention is not to be limited to the details given herein, but may be modified within the scope of the invention hereinafter claimed. For example, the invention is also applicable to a magnetic disk cartridge in which a smaller magnetic disk medium is housed within a casing. In this case, the above-described advantages are similarly obtained. Such a magnetic disk cartridge with a small magnetic disk medium is disclosed, for example, in U.S. Pat. No. 6,256,168 which is incorporated herein by reference.

What is claimed is:

1. A magnetic disk cartridge comprising:
a magnetic disk medium;
a casing, which has head slots, for rotatably housing said magnetic disk medium; and
dust-removing liners fixed to inner surfaces of said casing that face both sides of said magnetic disk medium;
wherein said dust-removing liners are formed from a porous material that has a great number of pores whose size is in a range of 60 to 100 μm.

2. The magnetic disk cartridge as set forth in claim 1, wherein said porous material has a molecular weight of 4,000,000 to 5,000,000.

3. The magnetic disk cartridge as set forth in claim 1, wherein said porous material is ultra-high molecular-weight-polyethylene.

4. The magnetic disk cartridge as set forth in claim 1, wherein said porous material has a pore density of 0.45 to 0.85.

5. The magnetic disk cartridge as set forth in claim 2, wherein said porous material has a pore density of 0.45 to 0.85.

6. The magnetic disk cartridge as set forth in claim 3, wherein said porous material has a pore density of 0.45 to 0.85.

7. The magnetic disk cartridge as set forth in claim 1, wherein said porous material contains an antistatic agent.

8. The magnetic disk cartridge as set forth in claim 2, wherein said porous material contains an antistatic agent.

9. The magnetic disk cartridge as set forth in claim 3, wherein said porous material contains an antistatic agent.
